(19) United States
(12) Patent Application Publication
(10) Pub. No.: US 2004/0265097 A1
(43) Pub. Date: Dec. 30, 2004

(54) Automated system for storing pallets for loading green tires, taking said pallets into a warehouse and taking said pallets out of the warehouse

(75) Inventors: Jae Hee Kim, Chungcheongnam-do (KR); Yong Gi Mim, Daejeon (KR)

Correspondence Address: JORDAN AND HAMBURG LLP, 122 EAST 42ND STREET, SUITE 4000, NEW YORK, NY, 10168, US

(73) Assignee: Hankook Tire Co., Ltd., Seoul (KR)

(21) Appl. No.: 10/830,158

(22) Filed: Apr. 22, 2004

(30) Foreign Application Priority Data
Jun. 19, 2003 (KR) 2003-39747

(51) Int. Cl. B65G 1/00

(52) U.S. Cl. 414/286

(57) ABSTRACT

An automated system for storing pallets for loading green tires, taking said pallets into a warehouse and taking said pallets out of the warehouse includes a conveyor section for taking pallets on which green tires are loaded into a warehouse; a gantry robot section for transferring said pallets to be taken out of the warehouse into a conveyor for taking said pallets out of the warehouse when said pallets are taken out of the warehouse while the warehoused pallets are transferred to a location on which said pallets are stacked; and a conveyor section for taking said pallets out of the warehouse by said gantry robot, in which the above gantry robot is operated in the directions of X axis, Y axis and Z axis.

### FIELD OF THE INVENTION

The present invention relates to an automated system for storing pallets for loading green tires, taking said pallets into a warehouse and taking said pallets out of the warehouse which stores automatically the pallets on which green tires are loaded to take the pallets into a warehouse and to take the pallets out of the warehouse storing and awaiting the green tires when the green tires manufactured by assembling various half-finished products in the building machine used in a forming process when the tires are manufactured are introduced into the vulcanizing machine used in a vulcanizing process as a subsequent process.

### DESCRIPTION OF THE PRIOR ART

In general, in a process for manufacturing the tires, various half-finished products are assembled in the building machine used in a forming process to obtain green tires, and then the green tires are stored and awaited to enable the green tires to vulcanize in a vulcanizing machine in a vulcanizing process which is a subsequent process. The green tires thus stored are transferred to the vulcanizing machine by request of the vulcanizing machine and then subjected to vulcanizing process to form the finished tires.

In a storing or awaiting place for green tires, on the other hand, it is important to classify and store the green tires according to size of green tire for enabling the green tires to first-in, first-out. Also, in order to maintain the production balance between a production plan in the forming process and a vulcanization plan in the vulcanizing process, the area to be required in the space in association with an amount of stored green tires becomes an important factor.

And, a method for storing the green tires can be divided mainly into two methods, i.e., a manual storage method and an automatic storage method. The former manual storage method means a method in which the green tires are loaded on a separate carrier or pallet and handled by the worker, the latter automatic storage method means a method in which the work performed by the worker is mechanized or automated to reduce the labor load of the worker. In particular, in case of the green tire having a large size and a heavy weight, problems on the safety may be occurred when the worker handles directly the green tires.

Also, taking into consideration of characteristics of rubber products, the first-in, first-out work for the tire should be performed. In case where the worker handles the green tires, however, there are drawbacks in that the first-in, first-out work is not carried out smoothly and the production lead time as a whole is lengthened so that the productivity is also lowered.

As a conventional automated storage system designed for solving the above problems in the green tire management process operating by the manual work, there is a system using a rack building and a stacker crane. This system comprises a rack capable of storing the green tires in a unit of single piece and a stacker crane which can convey automatically green tires and store them by forming a passage between racks. As compared with the manual storage method, the automated storage method has an effect capable of saving the space in the process.

In general, the manual storage method requires much space owing to horizontal storage, however, the automated storage method using a stacker crane can not only store horizontally the green tires, but also utilize a space so that the stacking efficiency is high.

However, although the method for storing automatically the green tires by using a stacker crane has a higher stacking efficiency than that of method for storing manually the green tires by using the manpower, the method for storing automatically the green tires by using a stacker crane has the following problems:

When the green tires are stored automatically in the limited space, it is difficult to satisfy the desired storage ability and the processing rate of warehousing and taking out of the warehouse. The above method can make inroads into working sphere of other equipments or other workers. In particular, it is difficult to install and to use the racks under the conditions such as low ceiling, obstructions and narrow space in the old building (plant).

### SUMMARY OF THE INVENTION

The present invention is contemplated to solve the problems in the prior art as described above. An object of the present invention is to provide an automated system for storing pallets for loading green tires, taking said pallets into a warehouse and taking said pallets out of the warehouse, which can increase a process ability to take said green tires into a warehouse and to take said green tires out of the warehouse in the limited space in situ, maximize a stacking ability for storing said green tires to enhance an efficiency of space utilization, and minimize an interference of working sphere when the work for taking said green tires into a warehouse and taking said green tires out of the warehouse is carried out.

In order to achieve the above object, an automated system according to the present invention comprises a conveyor section for taking pallets on which green tires are loaded into a warehouse; a gantry robot section for transferring said pallets to be taken out of the warehouse into a conveyor for taking said pallets out of the warehouse when said pallets are taken out of the warehouse while the warehoused pallets are transferred to a location on which said pallets are stacked; and a conveyor section for taking said pallets out of the warehouse by said gantry robot, in which the above gantry robot is operated in the directions of X axis, Y axis and Z axis.

### BRIEF DESCRIPTION OF THE DRAWINGS

FIG. 1 is a perspective view showing an overall structure of the automated system for storing automatically pallets for loading green tires, taking said pallets into a warehouse and taking said pallets out of the warehouse according to the present invention;

FIG. 2 is an enlarged perspective view of the pallet for loading the green tire, which is applied to the automated system for storing automatically pallets for loading green tires, taking said pallets into a warehouse and taking said pallets out of the warehouse according to the present invention; and

FIG. 3 is a side view of the pallet shown in FIG. 2.

### DETAILED DESCRIPTION OF THE PREFERRED EMBODIMENTS

Hereinafter, an embodiment of the present invention will be described in detail with reference to accompanying drawings.

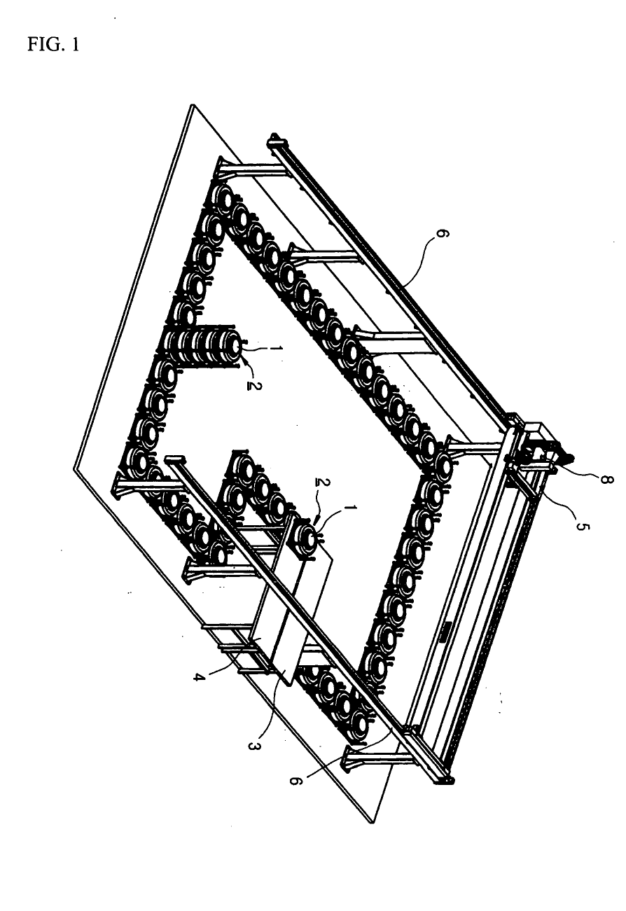

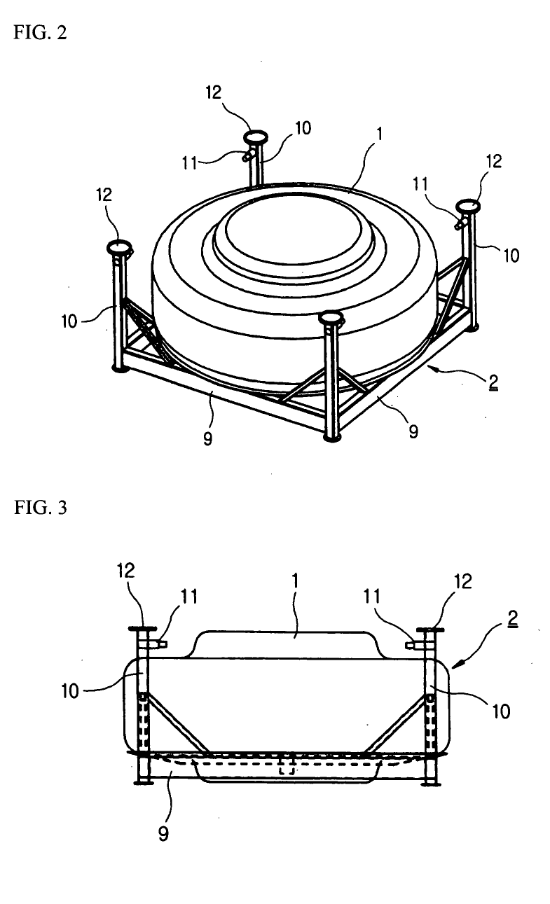

FIG. 1 is a perspective view showing an overall structure of the automated system for storing automatically pallets for loading green tires, taking said pallets into a warehouse and taking said pallets out of the warehouse according to the present invention. FIGS. 2 and 3 are views showing the pallet applied to the present invention.

An automated system according to the present invention comprises a conveyor section 3 for taking the pallet 2 on which a green tire 1 subjected to a forming process is loaded into the warehouse; a gantry robot section 5 for transferring said pallet 2 to be taken out of the warehouse to a conveyor section 4 for taking the pallet out of the warehouse when the pallet is taken out of the warehouse while the warehoused pallet 2 is transferred to a location on which the warehoused pallet is stacked and stored; and a conveyor section 4 for taking the pallet out of the warehouse by said gantry robot 5, in which the above gantry robot 5 is operated in the directions of X axis 6, Y axis 7 and Z axis 8, so that said pallet 2 is selectively transferred and positioned.

In order to handle the pallet 2 on which the green tire 1 is loaded when the gantry robot section 5 is moved in the direction of Z axis 8 as shown in FIG. 2 and FIG. 3, the handles are provided at posts 10 mounted vertically onto the four corners of a base frame 9, respectively. Each post 10 has an upper cap 12 mounted onto the upper surface thereof so as to use when the pallets 2 are stacked in multi layers as shown in FIG. 1.

A process for taking the pallet into a warehouse and taking the pallet out of the warehouse by an automated system according to the present invention is as follows:

The pallet 2 on which the green tire was loaded in advance in a unit of single piece as shown in FIG. 2 is supplied to the conveyor section 3 for taking the pallet into the warehouse as shown in FIG. 1. When the pallet 2 is reached to an end of the conveyor section 3 for taking the pallet into the warehouse, a conventional inventory control system matches the information on the size of the green tire 1 taken into the warehouse with the information on a place on which the green tires will be stacked by the gantry robot section 5. Then, the gantry robot section 5 is received a stacking command from the inventory control system to transfer the pallet 2 to a predetermined stacking location. At this time, the above gantry robot section 5 is moved in the directions of X axis 6, Y axis 7 and Z axis 8 to transfer the pallet 2 to a stacking/storing location.

Also, if necessary, the above pallets 2 can be stacked in multi layers when the pallets 2 are stacked and stored.

On the other hand, when the pallet is taken out of the warehouse, the inventory control system receives information on the size of the green tire which is required in the vulcanizing machine used in the vulcanizing process. According to the received information, the inventory control system commands the gantry robot section 5 to take the corresponding green tire out of the warehouse. As described above, the above gantry robot section 5 is moved to a corresponding location and lifts the pallet 2 on which the green tire is loaded, and then transfer said pallet to the conveyor section 4 for taking said pallet out of the warehouse.

### INDUSTRIAL APPLICABILITY

According to the present invention, the following effects can be obtained:

Firstly, the labor load of the worker may be decreased remarkably so that the productivity and efficiency of the labor may be increased; Secondly, an efficiency of space utilization for storing automatically the green tires in the limited space may be maximized; Thirdly, it is possible to maintain the quality of green tires uniformly by development of the pallet capable of storing the green tires without transforming the shape; and Fourthly, the long-term storage or unnecessary stock of green tires may be prevented in advance by first-in, first-out management in real time and on-line for the stock of green tires to enable the cost of production of tires to curtail.

It is intended that the embodiment of the present invention descried above and illustrated in the appended drawings should not be construed as limiting the technical spirit of the present invention. The scope of the present invention is defined only by the appended claims. Those skilled in the art can make various changes and modifications thereto without departing from its true spirit. Therefore, various changes and modifications obvious to those skilled in the art will fall within the scope of the present invention.

What is claimed is:

1. An automated system for storing the pallet for loading the green tire, taking said pallet into a warehouse and taking said pallet out of the warehouse comprising a conveyor section 3 for taking the pallet 2 on which the green tire 1 subjected to a forming process is loaded into the warehouse; a gantry robot section 5 for transferring said pallet 2 to be taken out of the warehouse to a conveyor section 4 for taking the pallet out of the warehouse when the pallet is taken out of the warehouse while the warehoused pallet 2 is transferred to a location on which the warehoused pallet is stacked and stored; and a conveyor section 4 for taking the pallet out of the warehouse by said gantry robot 5, in which the above gantry robot 5 is operated in the directions of X axis 6, Y axis 7 and Z axis 8, so that said pallet is selectively transferred and positioned.

2. The automated system according to claim 1, wherein said pallet 2 has handles 11 provided at posts 10 mounted vertically onto the four corners of a base frame 9 so as to handle the pallet 2 when the gantry robot 5 is moved in the direction of Z axis (8); and each post 10 has an upper cap 12 mounted onto the upper surface thereof so as to use when the pallets are stacked in multi layers.
